(19) United States
(12) Patent Application Publication
(10) Pub. No.: US 2026/0331053 A1
(43) Pub. Date: Oct. 22, 2026

(54) PIXEL DRIVING CIRCUIT AND DISPLAY PANEL

(71) Applicant: Everdisplay Optronics (Shanghai) Co., Ltd., Shanghai (CN)

(72) Inventors: Han ZHANG, Shanghai (CN); Jie LIU, Shanghai (CN); Ying-Hsiang TSENG, Shanghai (CN); Lina XIAO, Shanghai (CN)

(73) Assignee: Everdisplay Optronics (Shanghai) Co., Ltd., Shanghai (CN)

(21) Appl. No.: 19/564,516

(22) Filed: Mar. 12, 2026

(30) Foreign Application Priority Data
Mar. 17, 2025 (CN) 2025103076833

(51) Int. Cl. G09G 3/3233

(52) U.S. Cl. CPC G09G 3/3233; G09G 2300/0819; G09G 2300/0852; G09G 2310/08; G09G 2320/0233; G09G 2320/0247

(57) ABSTRACT

The present disclosure provides a pixel driving circuit and a display panel, the pixel driving circuit includes: a driving unit for driving a light-emitting element to emit light; a first switch unit for receiving a data signal; a second switch unit for controlling threshold voltage compensation; a first storage unit connected between a fourth node and a second node; a timing control circuit for controlling a conduction and cut-off of the first switch unit and the second switch unit respectively, to separate a data signal writing time from a compensation time, and controlling Vth compensation time to be greater than a line scan time; and in the light-emitting phase, pulse-resetting a source potential of the driving unit by outputting a pulse signal.

### CROSS REFERENCE

This application is based upon and claims priority to Chinese Patent Application No. 2025103076833, filed on Mar. 17, 2025, the entire contents thereof are incorporated herein by reference.

### TECHNICAL FIELD

The present disclosure relates to the field of circuits of display panels, and in particular, to a pixel driving circuit and a display panel.

### BACKGROUND

With the rapid development of display technology, the requirements of people on display devices are higher and higher, and in particular, in the fields of mobile devices, Virtual Reality (VR)/Augmented Reality (AR) devices, high-definition televisions and the like, the requirements on the performance of display screens are higher and higher. The refresh rate is one of important indicators for measuring the performance of the display screen.

The high refresh rate can provide a relatively smooth picture display effect, reduce motion blur, promote user experience, and has obvious advantages especially in scenes such as games, fast motion video playing and the like. In addition, the high refresh rate is also helpful for relieving eye fatigue and protecting vision. However, conventional pixel driving circuits face some technical challenges at high refresh rates. Since the scanning time of each row of pixels is shortened, the time for threshold voltage (Vth) compensation is also reduced accordingly, resulting in insufficient Vth compensation, thereby causing problems of display unevenness, luminance deviation, and the like, which seriously affect display quality. On the other hand, although the low refresh rate can obviously reduce the display power consumption and prolong the battery life of the device, under the low refresh rate, the threshold voltage drift and hysteresis effect of the driving transistor (DRIVER TFT) become more obvious, so that the OLED emits light unstably, the human eyes can perceive obvious screen flicker, and the viewing comfort level is reduced.

It should be noted that the information applied in the above background section is only for enhancing understanding of the background of the present disclosure and thus may include information that does not form the prior art that is already known to those of ordinary skill in the art.

### SUMMARY

An aspect of an embodiment of the present disclosure provides a pixel driving circuit, including:
a driving unit for driving a light-emitting element to emit light;
a first switch unit for receiving a data signal of a data input terminal and transmitting the data signal to a fourth node;
a second switch unit for controlling threshold voltage compensation and transmitting a compensated voltage to a second node;
a first storage unit connected between the fourth node and the second node;
a timing control circuit for outputting a control signal to a first control signal terminal, a second control signal terminal, a third control signal terminal and a fourth control signal terminal respectively to control a conduction and cut-off of the first switch unit and the second switch unit, thereby separating a data signal writing time from a threshold voltage compensation time, and to control a conduction time of the second switch unit to enable the threshold voltage compensation time to be longer than a line scan time; and in a light-emitting phase, outputting a pulse signal to the third control signal terminal to pulse-reset the driving unit.

Another aspect of an embodiment of the present disclosure provides a display panel including the pixel driving circuit according to the above.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and together with the specification, serve to explain the principles of the present disclosure. It is evident that the drawings in the following description are only some embodiments of the present disclosure and that other drawings may be obtained from these drawings without inventive effort for a person of ordinary skill in the art.

FIG. 1 is a schematic diagram showing a circuit connection of a pixel driving circuit according to an embodiment of the present disclosure; and

FIG. 2 is a waveform diagram of an internal compensation pixel driving circuit during operation according to an embodiment of the present disclosure.

T1—first transistor, T2—second transistor, T3—third transistor, T4—fourth transistor, T5—fifth transistor, T6—sixth transistor, T7—seventh transistor, T8—eighth transistor, T9—ninth transistor, T10—tenth transistor, N1—first node, N2—second node, N3—third node, N4—fourth node, N5—fifth node, C1—first capacitor, C2—second capacitor, C3—third capacitor, SN_T1—first control signal terminal, SN_T3—second control signal terminal, SN+1—third control signal terminal, SN−1—fourth control signal terminal, Data-data input terminal, ELVDD—first power supply terminal, ELVSS—second power supply terminal, Vint 1—first reference voltage input terminal, Vint 2—second reference voltage input terminal, Vint3—third reference voltage input terminal, Vint 4—fourth reference voltage input terminal, EM—enable signal input terminal.

### DETAILED DESCRIPTION

In order to make the technical problems solved by the present disclosure, the technical solutions adopted and the technical effects achieved more clear, the technical solutions of the embodiments of the present disclosure are described in further detail below with reference to the accompanying drawings, and it is obvious that the described embodiments are only some embodiments of the present disclosure, but not all embodiments. All other embodiments, which can be made by those skilled in the art based on the embodiments of the present disclosure without making any inventive effort, are intended to be within the protection scope of the present disclosure.

Furthermore, the described features, structures, or characteristics can be combined in any suitable manner in one or more embodiments. In the following description, numerous specific details are provided to give a thorough understanding of the embodiments of the present application. The person skilled in the art can recognize, however, that the technical solutions of the present application can be practiced without one or more of the specific details, or with other methods, modules, apparatus, steps, etc. In other instances, well-known modules, methods, apparatuses, implementations, steps, or operations are not shown or described in detail to avoid obscuring aspects of the present application.

Currently, most display devices on the market employ a fixed refresh rate or a few fixed refresh rates, such as 60 Hz, 90 Hz, 120 Hz, etc. This single or several refresh rate mode cannot meet the user's needs in different application scenarios. For example, a high refresh rate is unnecessary when browsing a static web page or reading an electronic book, but increases power consumption, while a low refresh rate causes screen jams and blurs when playing a game or watching a high-speed moving video.

Therefore, how to design a pixel driving circuit compatible with high and low refresh rates, which can not only provide high-quality image display at the high refresh rate, but also effectively reduce power consumption and screen flicker at the low refresh rate, has become an urgent technical problem to be solved in the technical field of display at present.

In view of this, the present disclosure provides a pixel driving circuit and a display panel, which can perform sufficient Vth compensation, improve display uniformity and picture quality at a high refresh rate, and effectively suppress the hysteresis effect of the driving transistor, reduce screen flicker, and improve viewing experience at a low refresh rate.

In the OLED display, pixel brightness is determined by the magnitude of current flowing through an Organic Light Emitting Diode (OLED) controlled by a driving transistor (DRIVER TFT). Due to process variations inherent to the TFT device, there is a difference in the threshold voltages (Vth) of the driving transistors of different pixels, resulting in that even though the same gate voltage is applied, the current flowing through the OLED may be different, thereby causing display luminance non-uniformity. The threshold voltage compensation technique aims to eliminate or mitigate the effect of such Vth difference on the display effect, and the basic principle is to detect or compensate Vth of the driving transistor by a specific circuit structure and driving timing to ensure uniformity of brightness of each pixel. In addition, the data writing process is a process of converting a digital signal representing the brightness of a pixel into an analog voltage signal and writing the analog voltage signal into a pixel capacitance, and the rate and accuracy of the process directly affect the refresh rate and display quality of the display screen. On the other hand, the hysteresis effect of the driving transistor, namely the phenomenon that the output current cannot reach a steady state value instantaneously after the gate voltage is changed, is particularly remarkable under the condition of low refresh rate, and can cause unstable light emission of the OLED and generate flicker perceived by human eyes. The pulse driving technique can reduce flicker at a low refresh rate while reducing average power consumption by applying a high voltage pulse for a short period of time to drive the OLED to emit light and utilizing the persistence effect of human eyes. Aiming at the problems that the conventional row-by-row Vth compensation mode is insufficient in compensation time under the high refresh rate and the flicker is caused by the hysteresis effect of the driving transistor under the low refresh rate, the present disclosure precisely controls the conduction and cut-off of the switch unit through the timing control circuit, realizes the separation of the data writing and the Vth compensation process, and ensures that the Vth compensation time is longer than the one-line scan time, thereby ensuring the sufficiency of the Vth compensation under the high refresh rate. Meanwhile, in the light-emitting phase, a plurality of pulse signals are applied to the source electrode of the driving unit, so that the hysteresis effect of the driving transistor is effectively restrained, screen flicker under a low refresh rate is lightened, and good compatibility of the high refresh rate and the low refresh rate is further realized.

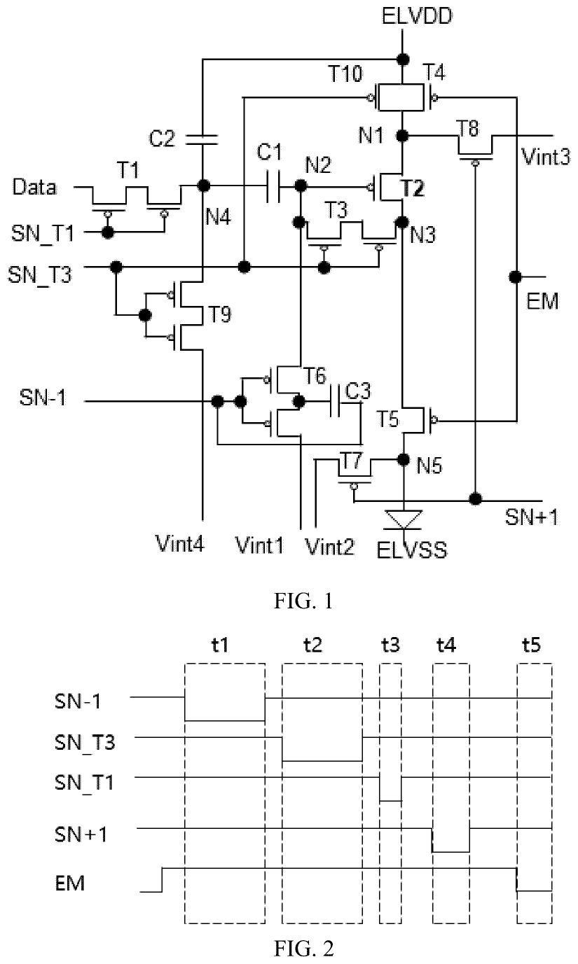

As shown in FIG. 1, an aspect of an embodiment of the present disclosure provides a pixel driving circuit, including the follows.

A driving unit is configured to drive a light-emitting element to emit light. Generally, a Thin Film Transistor (TFT) is used as a driving transistor to control a current flowing through the OLED, thereby controlling the light-emitting luminance of the OLED. In the embodiment of the present disclosure, the driving unit is preferably a thin film transistor, more preferably a P-type thin film transistor (TFT), for example, the second transistor T2 in FIG. 1 is a PMOS TFT. The gate of the second transistor T2 receives a voltage signal from the second node N2, a first terminal of the second transistor T2 is connected to the first node N1, a second terminal of the second transistor T2 is connected to the third node N3, and the current between the source and the drain of the second transistor T2 is controlled by the magnitude of the gate voltage, to drive the OLED to emit light. In other embodiments, the second transistor T2 may also employ other circuit structures or devices having similar driving functions.

A first switch unit is configured to receive a data signal of a data input terminal Data and transmit the data signal to a fourth node N4. In the embodiment of the present disclosure, the first switch unit is preferably a thin film transistor, more preferably a P-type thin film transistor, such as a PMOS TFT. The control terminal of the first switch unit is connected to the first control signal terminal SN_T1, the input terminal is connected to the data i nput terminal Data, and the output terminal is connected to the fourth node N4. When the first control signal terminal SN_T1 is at an active level, for example, a low level, the first switch unit is turned on to transmit the data signal to the fourth node N4; and when the first control signal terminal SN_T1 is at an inactive level, for example, a high level, the first switch unit is turned off to prevent the data signal from being transmitted. In other embodiments, the first switch unit can also employ other circuit structures or devices having a switching function, such as a transmission gate, and the like.

A second switch unit is configured to control threshold voltage compensation and transmit the compensated voltage to the second node N2. In the embodiment of the present disclosure, the second switch unit is preferably a thin film transistor, more preferably a P-type thin film transistor, such as a PMOS TFT. The control terminal of the second switch unit is connected to the second control signal terminal SN_T3, the input terminal is connected to the third node N3, and the output terminal is connected to the second node N2. By controlling the level of the second control signal terminal SN_T3, the second switch unit can be controlled to be turned on and off, thereby controlling the Vth compensation process. In other embodiments, the second switch unit can also employ other circuit structures or devices having a switching function.

A first storage unit is connected between the fourth node N4 and the second node N2. The first storage unit is used for keeping the voltage of the second node stable in the data writing phase and the light-emitting phase, so that the normal operation of the driving transistor is ensured. In the embodiment of the present disclosure, the first storage unit is preferably a capacitor, in some embodiments, the first storage unit includes a first capacitor C1, and the first capacitor C1 is connected between the fourth node N4 and the second node N2, and is used for storing the charge written into the fourth node N4 during the data writing phase, and influencing the potential of the second node N2 through the capacitive coupling effect, so as to control the gate voltage of the second transistor T2. Specifically, when the data signal is written into the fourth node N4 through the first switch unit, the potential of the fourth node N4 changes, and since the voltage across the first capacitor C1 cannot be suddenly changed, the potential of the second node N2 also changes accordingly, and the magnitude of the change depends on the capacitance value of the first capacitor C1 and the capacitance value(s) of other related capacitor(s). This capacitive coupling effect enables the data signal to be effectively transferred to the gate electrode of the second transistor T2, thereby controlling the light-emitting luminance of the OLED. In addition, in the light-emitting phase, the first capacitor C1 also plays a role in maintaining the potential of the second node N2 stable, and prevents the gate voltage of the second transistor T2 from fluctuating due to leakage and other factors, thereby affecting the light-emitting stability of the OLED.

In some alternative embodiments, the pixel driving circuit further includes a second capacitor C2, where the second capacitor C2 is connected between the first power supply terminal ELVDD and the fourth node N4, and is used to stabilize the potential of the fourth node N4 during the Vth compensation phase, and assist the first capacitor C1 in maintaining the potential of the fourth node N4 stable during the data writing phase. Specifically, in the Vth compensation phase, the potential of the fourth node N4 can be precharged to a specific voltage value by controlling the relevant switch unit, and the second capacitor C2 can store the charge corresponding to the voltage, and plays a role in maintaining the potential stability of the fourth node N4 in the subsequent data writing phase and the light-emitting phase, so that the influence of factors such as interference or leakage of other circuit element(s) on the potential of the fourth node N4 is reduced, and the accuracy of data writing and Vth compensation is improved.

The timing control circuit is used for outputting a control signal to the first control signal terminal SN_T1, the second control signal terminal SN_T3, the third control signal terminal SN+1 and the fourth control signal terminal SN−1 respectively, to control the conduction and cut-off of the first switch unit and the second switch unit, thereby separating the data signal writing time from the threshold voltage compensation time, and to control the conduction time of the second switch unit so that the compensation time of the threshold voltage Vth is longer than one-line scan time, and outputting a pulse signal to the third control signal terminal SN+1 in the light-emitting phase to perform pulse reset on the potential of the driving unit. Specifically, the timing control circuit generates a specific timing signal such that the first switch unit and the second switch unit are turned on or off, respectively, in different periods of time, thereby achieving time sharing of data writing and Vth compensation. The timing control circuit controls the conduction time of the second switch unit so that the Vth compensation time can exceed the one-line scan time to ensure that Vth is sufficiently compensated. In addition, in the light-emitting phase, the timing control circuit outputs a pulse signal through the third control signal terminal SN+1 to control the conduction and cut-off of at least two switch units connected to the first terminal of the second transistor T2, so as to realize the pulse reset of the first terminal potential of the second transistor T2, thereby reducing the hysteresis effect of the driving transistor. The timing control circuit can be implemented by various known timing control circuit structures, such as a shift register, a logic gate circuit, and the like.

In some embodiments, the first switch unit includes a first transistor T1, a gate of the first transistor T1 is connected to the first control signal terminal SN_T1, a first terminal of the first transistor T1 is connected to the data input terminal Data, and a second terminal of the first transistor T1 is connected to the fourth node N4. Specifically, in the present embodiment, the first switch unit employs a thin film transistor to realize transmission control of the data signal. The first control signal terminal SN_T1 signal is used for controlling the conduction and cut-off of the first transistor T1. The first transistor T1 is turned on when the first control signal terminal SN_T1 is at an active level, e.g., a low level; and the first transistor T1 is turned off when the first control signal terminal SN_T1 is at an inactive level, e.g., a high level. By controlling the level change of the first control signal terminal SN_T1, the writing timing of the data signal can be precisely controlled. The data input terminal Data is used for providing a data signal to be written into the pixel, the data signal is typically an analog voltage signal, representing the brightness information of the pixel. The first terminal, e.g., a source, of the first transistor T1 is connected to the data input terminal Data to transmit the data signal when the first transistor T1 is turned on. The second terminal, e.g., a drain, of the first transistor T1 is connected to the fourth node N4. When the first transistor T1 is turned on, the data signal is transmitted from the data input terminal Data terminal to the fourth node N4 through the first transistor T1, thereby completing the data writing process. In other embodiments, the first switch unit further includes a ninth transistor T9, a gate of the ninth transistor T9 is connected to the second control signal terminal SN_T3, a first terminal of the ninth transistor T9 is connected to the fourth reference voltage input terminal Vint4, and a second terminal of the ninth transistor T9 is connected to the fourth node N4. The ninth transistor T9 is used in the present embodiment to reset the fourth node N4 in the threshold voltage (Vth) compensation phase. Specifically, in the Vth compensation phase, the second control signal terminal SN_T3 outputs an active level, for example, a low level, so that the ninth transistor T9 is turned on, and the potential of the fourth node N4 is pulled to the potential of the fourth reference voltage input terminal Vint4. This initializes the potential of the fourth node N4 to a known state before Vth compensation is performed, thereby ensuring the accuracy of Vth compensation. In other phases, such as a data writing phase and a light-emitting phase, the second control signal terminal SN_T3 outputs an inactive level, such as a high level, so that the ninth transistor T9 is turned off to avoid the influence on the data writing and light-emitting process. The ninth transistor T9 is preferably a thin film transistor (TFT), more preferably a P-type metal oxide semiconductor thin film transistor (PMOS TFT).

By adopting the above implementations, the first control signal terminal SN_T1 is utilized to control the conduction and cut-off of the first transistor T1, so that the writing time of the data signal can be accurately controlled, and the separation between the writing time of the data signal and the compensation time of the threshold voltage is realized by cooperating with the timing control circuit, which lays a foundation for the subsequent Vth compensation and the driving OLED to emit light. It should be noted that the use of the PMOS TFT as the first switch unit in the present embodiment as shown in FIG. 1 is only a preferred implementation, and is not a limitation of the present disclosure. Any circuit structure or device capable of realizing data signal transmission control and the technical scheme capable of realizing separation of data signal writing time and threshold voltage compensation time by matching with a timing control circuit fall within the protection scope of the present disclosure.

In some embodiments, the second switch unit includes a third transistor T3, a gate of the third transistor T3 is connected to the second control signal terminal SN_T3, a first terminal of the third transistor T3 is connected to the third node N3, and a second terminal of the third transistor T3 is connected to the second node N2. In the embodiment of the present disclosure, the second control signal terminal SN_T3 is used to control the conduction and cut-off of the third transistor T3. The third transistor T3 is turned on when the second control signal terminal SN_T3 is at an active level, e.g., a low level; and the third transistor T3 is turned off when the second control signal terminal SN_T3 is at an inactive level, e.g., a high level. By controlling the level change of the second control signal terminal SN_T3, the start time and end time of Vth compensation can be precisely controlled. In combination with the timing control circuit, Vth compensation time can be made longer than one-line scan time. The third node N3 is connected to the second terminal of the second transistor T2. The second node N2 is connected to the gate of the second transistor T2. When the third transistor T3 is turned on, the Vth-compensated voltage is transferred from the third node N3 to the second node N2 through the third transistor T3, thereby adjusting the gate voltage of the second transistor T2 to compensate for the threshold voltage shift thereof. In other embodiments, the second switch unit further includes a tenth transistor T10, and the tenth transistor T10 is connected between the first power supply terminal ELVDD and the first node N1 and is controlled by the second control signal terminal SN_T3 signal. The tenth transistor T10 is used in the present embodiment to supply the compensation voltage, for example, the potential of the first power supply terminal ELVDD, to the first node N1 in the threshold voltage (Vth) compensation phase. Specifically, in the Vth compensation phase, the second control signal terminal SN_T3 outputs an active level, for example, a low level, so that the third transistor T3 and the tenth transistor T10 are simultaneously turned on. The turn-on of the tenth transistor T10 applies the voltage of the first power supply terminal ELVDD to the first node N1. In combination with the connection relation of the circuits and timing control, this helps to establish an appropriate voltage difference between the gate and the source of the second transistor T2, i.e., between the second node N2 and the third node N3, in the Vth compensation phase, thereby achieving Vth compensation. By controlling the duration of the active level of the second control signal terminal SN_T3, the duration of Vth compensation can be controlled, so that Vth compensation time is longer than one-line scan time. In other phases, such as a data writing phase and a light-emitting phase, the second control signal terminal SN_T3 outputs an inactive level, such as a high level, so that the tenth transistor T10 is turned off to avoid the influence on the data writing and light-emitting processes. The tenth transistor T10 is preferably a thin film transistor (TFT), more preferably a P-type metal oxide semiconductor thin film transistor (PMOS TFT).

By adopting the above embodiment, the second control signal terminal SN_T3 is used to control the conduction and cut-off of the third transistor T3, and in combination with other related circuit and timing control, Vth compensation can be effectively implemented, and the Vth compensation time can be precisely controlled to be longer than one-line scan time, so that the sufficiency of Vth compensation can be ensured under high refresh rate, and uniformity of display images can be significantly improved. It should be noted that the use of PMOS TFT as the second switch unit in this embodiment is only a preferred embodiment, and is not a limitation of the present disclosure. Any circuit structure or device capable of implementing Vth compensation control and voltage transmission, and the technical scheme capable of implementing Vth compensation time longer than one-line scan time in cooperation with the timing control circuit should fall within the protection scope of the present disclosure.

In some embodiments, the pixel driving circuit further includes a third switch unit, the third switch unit includes a sixth transistor T6, the sixth transistor T6 is a double-gate thin film transistor, a gate thereof is connected to the fourth control signal terminal SN-1, a first terminal of the sixth transistor T6 is connected to the first reference voltage input terminal Vint1, and a second terminal of the sixth transistor T6 is connected to the second node N2. The sixth transistor T6 adopts a double-gate thin film transistor (Double-Gate TFT) structure, and the double-gate TFT has better switching characteristics, lower leakage current, and higher stability than the conventional single-gate TFT. In the embodiment of the present disclosure, the double-gate TFT is adopted as the sixth transistor T6, so that the conduction and cut-off of the sixth transistor T6 can be controlled more effectively, the influence of the double-gate TFT on other circuit element(s) is reduced, and particularly in the Vth compensation and reset phase, the potential of the second node N2 can be stabilized better, and the precision of compensation and reset is improved. The signal of the fourth control signal terminal SN−1 is used to control the conduction and cut-off of the sixth transistor T6. The sixth transistor T6 is turned on when the fourth control signal terminal SN−1 is at an active level, e.g., a low level; and the sixth transistor T6 is turned off when the fourth control signal terminal SN−1 is at an inactive level, e.g., a high level. By controlling the level change of the fourth control signal terminal SN−1, the operation state of the sixth transistor T6 can be controlled. In combination with the timing control circuit, the sixth transistor T6 can be turned on for a certain period of time to stabilize the potential of the second node N2. The first reference voltage input Vint1 provides a stable reference voltage for assisting in stabilizing the potential of the second node N2. When the sixth transistor T6 is turned on, the voltage of the first reference voltage input terminal Vint1 can affect the potential of the second node N2, and the influence of noise and interference on the potential of the second node N2 is reduced. In other embodiments, the third switch unit can be implemented using other circuit structures or devices having similar functions.

By adopting the above embodiment, the double-gate TFT is used as the sixth transistor T6, and the fourth control signal terminal SN−1 is used to control the sixth transistor T6, so that the potential of the second node N2 can be more effectively stabilized, the influence of noise and interference on the potential of the second node N2 is reduced, thereby improving the precision of Vth compensation and reset, and finally helping to improve the quality of the display picture. The use of the double-gate TFT also enhances the stability of the circuit and improves the reliability of the device. It should be noted that using the double-gate PMOS TFT as the sixth transistor T6 of the third switch unit in the present embodiment is only a preferred implementation, and is not a limitation of the present disclosure. Any circuit structure or device capable of stabilizing the potential of the second node N2 and the scheme implementing related functions in cooperation with the timing control circuit should fall within the protection scope of the present disclosure.

In some embodiments, the pixel driving circuit further includes a third storage unit connected between a midpoint of the double-gate thin film transistor of the sixth transistor T6 and a gate of the sixth transistor T6 for stabilizing the potential of the second node N2. In the embodiment of the present disclosure, in order to further improve the stability of the potential of the second node N2, the third storage unit further includes a third capacitor C3. The double-gate TFT has two gates, which can be used in parallel or controlled separately. There is a midpoint between two gates of the double-gate TFT, and due to its special structure, there is a certain parasitic capacitance itself. After the additional capacitor, namely the third capacitor C3, is connected, the parasitic capacitor is increased, and a capacitor voltage-dividing network is formed. The capacitive voltage-dividing network can effectively filter high-frequency noise and interference and reduce the potential fluctuation of the second node N2 caused by factors such as switching actions or electric leakage of other circuit element(s). When two gates are used in parallel, as shown in FIG. 1, there is a midpoint between the two gates, which typically has a certain capacitive effect. The third capacitor C3 is not directly connected between the N2 node and the gate of the sixth transistor T6, but is connected between the midpoint of the double gate of the sixth transistor T6 and the gate of the sixth transistor T6. This connection manner utilizes the inherent capacitance characteristic of the double-gate TFT and combines with the additional third capacitor C3 to form a more effective capacitor network, so that the potential of the second node N2 is more effectively stabilized. The third capacitor C3 has the function of stabilizing the potential of the second node N2 during different operation phases, such as Vth compensation phase, data writing phase and light-emitting phase, and reducing the influence of noise and interference on the potential of the second node N2. Since the second node N2 is directly connected to the gate of the second transistor T2, the stability of the potential of the second node N2 directly affects the operating state of the second transistor T2, thereby affecting the light-emitting brightness of the OLED.

By adopting the above implementation, the potential of the second node N2 can be more effectively stabilized, noise and interference can be reduced, accuracy of Vth compensation can be improved, and finally quality of the display picture can be improved by using the third capacitor C3 connected between the midpoint of the double-gate TFT and the gate. Especially when the driving transistor works for a long time or works under high ambient temperature, the stabilizing effect of the third storage unit is more obvious, and the problems of flickering or uneven brightness of the display picture can be effectively prevented. It should be noted that the use of the third capacitor C3, which is a capacitor connected between the midpoint of the double-gate TFT and the gate, to stabilize the potential of the second node N2 in this embodiment is merely a preferred implementation, and is not a limitation of the present disclosure. Any circuit structure or device capable of effectively stabilizing the potential of the second node N2 should fall within the protection scope of the present disclosure.

In some embodiments, to mitigate the hysteresis effect of the driving unit at low refresh rates, thereby reducing screen flicker, the pixel driving circuit further includes:
a fourth switch unit connected between the second reference voltage input terminal Vint2 and the fifth node N5. In the embodiment of the present disclosure, the fourth switch unit is configured to pull the potential of the fifth node N5, i.e. the first terminal of the OLED, to the potential of the second reference voltage input Vint2 in the reset phase.

A fifth switch unit is connected between the driving unit and the third reference voltage input terminal Vint3. The timing control circuit controls the conduction and cut-off of the fourth switch unit and the fifth switch unit through the third control signal terminal SN+1 to realize pulse reset of the driving unit. The hysteresis effect of the second transistor T2 may cause its output current to exhibit different characteristics due to different history states when the same gate voltage is applied. In an embodiment of the present disclosure, the fifth switch unit is configured to pull the potential of the first terminal of the driving unit to the potential of the third reference voltage input Vint3 in the reset phase. In the light-emitting phase, that is, the OLED light-emitting period, the timing control circuit outputs a series of pulse signals through the third control signal terminal SN+1. By reasonably setting the values of the second reference voltage input terminal Vint2 and the third reference voltage input terminal Vint3, VGS change of the second transistor T2 in the reset period can be effectively controlled, so that the optimal reset effect is achieved, further, the hysteresis effect of the second transistor T2 can be effectively restrained, the instability of OLED luminescence is reduced, and screen flicker is reduced.

By adopting the above implementation, the fourth switch unit and the fifth switch unit are controlled by the timing control circuit, so that the pulse reset of the first terminal potential of the driving unit is realized, the hysteresis effect of the second transistor T2 can be effectively restrained, the screen flicker under the low refresh rate is obviously lightened, and the viewing comfort level is improved. In addition, by adjusting the frequency and amplitude of the pulse, the display performance can be further improved by optimizing according to different display requirements.

In some embodiments, the pixel driving circuit further includes a fourth switch unit including a seventh transistor T7, a gate of the seventh transistor T7 is connected to the third control signal terminal SN+1, a first terminal of the seventh transistor T7 is connected to the second reference voltage input Vint2, and a second terminal of the seventh transistor T7 is connected to the fifth node N5. In the embodiment of the present disclosure, the seventh transistor T7 is preferably a thin film transistor (TFT), and more preferably a PMOS TFT. When the third control signal terminal SN+1 is at an active level, for example, a low level, the seventh transistor T7 is turned on, and pulls the potential of the fifth node N5, i.e., the second terminal of the second transistor T2, to Vint2, to realize reset.

The fifth switch unit includes an eighth transistor T8, a gate of the eighth transistor T8 is connected to the third control signal terminal SN+1, a first terminal of the eighth transistor T8 is connected to the third reference voltage input terminal Vint3, and a second terminal of the eighth transistor T8 is connected to the first node N1, i.e., the first terminal of the driving unit. In the embodiment of the present disclosure, the eighth transistor T8 is preferably a PMOS TFT. When the third control signal terminal SN+1 is at an active level, for example, a low level, the eighth transistor T8 is turned on to pull the potential of the first node N1 to the potential of the third reference voltage input terminal Vint3. It is noted that since the second terminal of the eighth transistor T8 is connected to the first node N1, i.e. the first terminal of the second transistor T2, the turn-on of the eighth transistor T8 is actually indirectly influencing the change of the potential of the first terminal of the driving unit by influencing the potential of the first terminal of the driving unit. In combination with the action of the seventh transistor T7, the seventh transistor T7 pulls the potential of the fifth node N5 to the potential of the second reference voltage input Vint2, and the eighth transistor T8 pulls the potential of the first node N1 to the potential of the third reference voltage input Vint3. The pulse type reset of the driving unit, namely the second transistor T2 is realized by simultaneously controlling the conduction and cut-off of the seventh transistor T7 and the eighth transistor T8 through the pulse type change of the signal of the third control signal terminal SN+1.

In some embodiments, at least the transistor in the first switch unit and the transistor in the second switch unit are double-gate thin film transistors. Compared with a single gate TFT, the double-gate TFT has smaller leakage current and higher stability, and the two gates of the double-gate TFT can more effectively control the formation and conduction of a channel, so that the leakage current is reduced, and the switching speed and stability of the device are improved. The first switch unit is used for controlling the writing of data signals, and the performance of the first switch unit directly influences the accuracy and the speed of data writing. By adopting the double-gate TFT as the transistor in the first switch unit, leakage current can be effectively reduced, switching speed is improved, and therefore accuracy of data writing is improved. The second switch unit is used to control Vth compensation, and the performance of the second switch unit directly affects the accuracy of Vth compensation. By adopting the double-gate TFT as the transistor in the second switch unit, leakage current can be also effectively reduced, switching speed is also improved, thereby improving accuracy of Vth compensation. Specifically, in the embodiment of the present disclosure, in order to further improve the performance and stability of the circuit, particularly to better stabilize the potentials of the second node N2 and the fourth node N4 and improve the hysteresis and the leakage phenomenon, at least the transistors in the first switch unit and the second switch unit adopt the Double-gate thin film transistor (Double-gate TFT) structure. Preferably, the thin film transistors (TFTs) connected to the second node N2 and the fourth node N4, that is, the first transistor T1, the third transistor T3 and the ninth transistor T9 are all double-gate TFTs, and the double-gate TFTs have smaller leakage current than the single gate TFTs, so that the leakage of charges can be reduced, and the voltage stability of the nodes can be better maintained.

By adopting the above implementation, the double-gate TFT is used for replacing part or all of the thin film transistors (TFTs) connected with the second node N2 and the fourth node N4, the electric potentials of the second node N2 and the fourth node N4 can be more effectively stabilized, and the electric leakage and hysteresis effects are reduced, so that the screen flicker perceived by human eyes is improved, and the effect is more obvious especially under the low refresh rate. This allows the pixel driving circuit of the present disclosure to support lower refresh rate displays, such as 30 Hz or even displays below 30 Hz, thereby further reducing display power consumption while ensuring display quality. It should be noted that the replacement of the transistors in at least the first switch unit and the second switch unit with the double-gate TFT in this embodiment, and preferably the replacement of the TFTs connecting the second node N2 and the fourth node N4 with the double-gate TFT is only a preferred implementation, and is not a limitation of the present disclosure. Any circuit structure or device capable of effectively reducing leakage current and improving node potential stability, thereby improving display effect should fall within the protection scope of the present disclosure.

In some embodiments, the thin film transistors (TFTs) connected to the first capacitor C1 and the second capacitor C2 is not limited to a P-type TFT or an N-type TFT. Specifically, the thin film transistors (TFTs) connected to the first capacitor C1 and the second capacitor C2, for example, the first transistor T1, the third transistor T3, the sixth transistor T6, and the ninth transistor T9 may adopt P-type TFTs, i.e., PMOS TFTs, as transistors in the switch unit. Preferably, the thin film transistors (TFTs) connected to the first capacitor C1 and the second capacitor C2 are N-type TFTs. Leakage current of a transistor is one of the important factors affecting circuit performance. Leakage currents can cause leakage of charge, thereby affecting the stability and power consumption of the circuit. In the pixel driving circuit, the leakage current may cause a reduction in the charge stored on the capacitor, thereby affecting the display brightness. Particularly at low refresh rates, the effect of leakage currents is more pronounced due to the long refresh period. By using the transistor with relatively low leakage current characteristic, the charge leakage can be effectively slowed down, and the display effect can be improved. The refresh rate can be further reduced by around 1 Hz. N-type TFTs may have lower leakage current characteristics under certain process conditions, for example, using oxide semiconductor materials (e.g., IGZO). The lower leakage current means that the leakage speed of the charges stored on the first capacitor C1 and the second capacitor C2 is slower, so that the potential of the node can be kept stable for a longer time, which is suitable for application scenes with extremely low refresh rate.

In some embodiments, the light-emitting element is an Organic Light-Emitting Diode (OLED). An OLED is composed of multiple layers of organic thin films, connected between a cathode and an anode. Specifically, in the present embodiment, the pixel driving circuit is used to drive an Organic Light Emitting Diode (OLED) to emit light. An OLED is a current-driven light-emitting device whose light-emitting luminance is proportional to the magnitude of current flowing therethrough. Under the action of the electric field, electrons and holes are respectively injected into the organic layer from the cathode and the anode, and are recombined in the light-emitting layer to generate photons and emit light. The OLED has the advantages of self-luminescence, wide viewing angle, high contrast ratio, high response speed, low power consumption and the like, and is widely applied to the display field. In the present disclosure, the OLED is connected between the fifth node N5 and the second power source terminal ELVSS, and the magnitude of current flowing therethrough is controlled by the driving unit, thereby controlling the light-emitting luminance thereof. It should be noted that the use of an OLED as a light-emitting element in this embodiment is only a preferred implementation, and is not a limitation of the present disclosure. Any element capable of driving light emission by current and capable of being used in cooperation with the pixel driving circuit of the present disclosure should fall within the protection scope of the present disclosure.

Based on the same inventive concept, another aspect of the embodiments of the present disclosure also provides a display panel, including the above pixel driving circuit. The display panel can be applied to any product or component with a display function, such as a mobile phone, a tablet personal computer, a television, a display, a notebook computer, a digital photo frame, a navigator and the like. The specific implementation of the display panel can be referred to the above embodiments of the pixel driving circuit, and the repetition of the technical solution and the technical effect are not be repeated.

As shown in FIG. 2, a waveform diagram of a pixel driving circuit during operation according to an embodiment of the present disclosure is shown. Based on the same inventive concept, another aspect of the embodiments of the present disclosure further provides a driving method of a pixel driving circuit, including the following phases.

In the t1 phase, i.e. the initialization phase, the fourth control signal terminal SN−1 is at an active level, e.g. a low level, the sixth transistor T6 is turned on, the voltage of the first reference voltage input terminal Vint1 is applied to the second node N2, and the reset is performed on the node of the second node N2, so that the potential of the second node N2 is reset to the potential of the first reference voltage input terminal Vint 1. The enable signal input terminal EM is at an inactive level, i.e., a high level, the fourth transistor T4 and the fifth transistor T5 are turned off, and the second transistor T2 and the OLED are not operated. The first control signal terminal SN_T1, the second control signal terminal SN_T3 and the third control signal terminal SN+1 are at an inactive level (high level), and the first transistor T1, the third transistor T3, the seventh transistor T7, the eighth transistor T8, the ninth transistor T9 and the tenth transistor T10 are turned off. The purpose of the t1 phase is to initialize the potential of the second node N2 in preparation for subsequent Vth compensation.

In the t2 phase, i.e. the Vth compensation phase, when the second control signal terminal SN_T3 is at an active level, i.e. at a low level, the third transistor T3, the ninth transistor T9 and the tenth transistor T10 are turned on. The ninth transistor T9 is turned on, and the voltage of the fourth reference voltage input terminal Vint4 is applied to the fourth node N4 to initialize the fourth node N4. The tenth transistor T10 is turned on, and the voltage of the first power supply terminal ELVDD is applied to the first node N1. The third transistor T3 is turned on, the potential of the first node N1 is transferred to the third node N3 through the second transistor T2, the potential of the second terminal of the second transistor T2 starts to rise, and then is transferred to the second node N2 through the third transistor T3, under the charging action of the first capacitor C1, the potential of the second node N2 is gradually raised to the first power supply terminal ELVDD+Vth, the potential of the gate of the second transistor T2, namely the potential of the second node N2, is raised to ELVDD+Vth, and the threshold voltage Vth of the second transistor T2 is compensated by the first power supply terminal ELVDD, namely, N2=ELVDD+Vth.

The compensation time at this phase may be greater than the one-line scan time, ensuring that Vth is sufficiently compensated. The fourth control signal terminal SN−1, the first control signal terminal SN_T1, the enable signal input terminal EM, and the third control signal terminal SN+1 are at an inactive level, i.e., a high level, and the first transistor T1, the fourth transistor T4, the fifth transistor T5, the sixth transistor T6, the seventh transistor T7, and the eighth transistor T8 are turned off. The purpose of the t2 phase is to perform Vth compensation on the second transistor T2 and ensure that the compensation time is longer than the one-line scan time.

In the T3 phase, i.e. the data writing phase, the first control signal terminal SN_T1 is at a low level, the first transistor T1 is turned on, and the data signal of the data input terminal Data is written into the fourth node N4, so that the potential of the fourth node N4 is changed from the potential of the fourth reference voltage input terminal Vint4 to the potential of the data input terminal Data, i.e. ΔN4=Data−Vint 4. The potential of the second node N2 is coupled with ΔN4, and since the first capacitor C1 is connected between the fourth node N4 and the second node N2, the change of the potential of the fourth node N4 affects the potential of the second node N2 by the capacitive coupling effect, so that

N2=ELVDD+Vth+A*(Data−Vint4)

where A=C1/C_{total_N2}, C_{total_N2} is the sum of all capacitances of the second node N2. When the first capacitance C1 is larger than the other capacitances, A≈1, then N2≈ELVDD+Vth+Data−Vint4. The fourth control signal terminal SN−1, the second control signal terminal SN_T3, the enable signal input terminal EM, and the third control signal terminal SN+1 are at a high level, and the third transistor T3, the fourth transistor T4, the fifth transistor T5, the sixth transistor T6, the seventh transistor T7, the eighth transistor T8, the ninth transistor T9, and the tenth transistor T10 are turned off. The purpose of this phase is to write the data signal into the pixel circuit and to transfer the data signal to the driving unit, i.e. the gate of the second transistor T2, using the capacitive coupling effect.

In the T4 phase, i.e. the reset phase, the third control signal terminal SN+1 is at a low level, the seventh transistor T7 is turned on, and the potential of the fifth node N5 is pulled to the potential of the second reference voltage input terminal Vint2, so as to reset the OLED device. The eighth transistor T8 is turned on, pulls the potential of the first node N1 to the potential of the third reference voltage input terminal Vint3, and simultaneously controls the conduction and cut-off of the seventh transistor T7 and the eighth transistor T8, so as to realize the pulse reset of the second transistor T2 of the driving unit, and improve the hysteresis effect of the second transistor T2. The fourth control signal terminal SN−1, the first control signal terminal SN_T1, the second control signal terminal SN_T3, and the enable signal input terminal EM are at a high level, and the first transistor T1, the third transistor T3, the fourth transistor T4, the fifth transistor T5, the sixth transistor T6, the ninth transistor T9, and the tenth transistor T10 are turned off. The purpose of this phase is to reset the OLED device and to achieve a pulse reset by influencing the potential of the driving unit to mitigate the hysteresis effect of the second transistor T2.

In the T5 phase, namely the light-emitting phase, the enable signal input terminal EM is at a low level, the fourth transistor T4 and the fifth transistor T5 are conducted, and the second transistor T2 of the driving unit starts to work, to drive the OLED to emit light. The current I_{OLED} flowing through the OLED can be expressed by the following formula:

I_{OLED}=K*(VGS−Vth)²=K*(N2−ELVDD−Vth)²=K(ELVDD+Vth+Data−Vint4−ELVDD−Vth)²=K(Data−Vint4)²

It can be seen that the current of the OLED is proportional to the square of the difference between the Data signal and Vint4, and is independent of Vth of the driving unit, thereby achieving Vth compensation. The fourth control signal terminal SN−1, the first control signal terminal SN_T1, the second control signal terminal SN_T3, and the third control signal terminal SN+1 are at a high level, and the first transistor T1, the third transistor T3, the sixth transistor T6, the seventh transistor T7, the eighth transistor T8, the ninth transistor T9, and the tenth transistor T10 are turned off. The purpose of this phase is to drive the OLED to emit light and to achieve a current output that is related to the data signal.

By the above driving method, the pixel driving circuit of the present disclosure can effectively separate data writing and Vth compensation time and enable the Vth compensation time to be longer than one-line scan time, so that full Vth compensation can be performed under high refresh rate, and uniformity of a display picture is improved. Meanwhile, by performing pulse reset in the light-emitting phase, screen flicker at a low refresh rate can be effectively reduced. Therefore, the present disclosure can be well compatible with high and low refresh rate display, and improves the display quality and the user experience. It should be noted that the waveform diagram shown in FIG. 2 and the driving method described above are only a preferred implementation, and are not limiting of the present disclosure. The frequency, amplitude, duty cycle of the pulse signals, and the timing relationships of the control signals, and the voltage values of the first reference voltage input terminal Vint1, the second reference voltage input terminal Vint2, the third reference voltage input terminal Vint3, and the fourth reference voltage input terminal Vint4 can be adjusted according to specific circuit parameters and display requirements. Any driving method capable of achieving separation of data writing and Vth compensation time, Vth compensation time being longer than one-line scan time, and pulse resetting in the light-emitting phase should fall within the protection scope of the present disclosure.

In summary, the pixel driving circuit, the driving method and the display panel of the present disclosure precisely control the conduction and cut-off of the switch units through the timing control circuit, and completely separate the data writing and Vth compensation processes, so that the Vth compensation process is not limited by the scanning time of each row of pixels. This allows sufficient Vth compensation to be performed at high refresh rates as well, supporting higher refresh rates, e.g., above 240 Hz. By precisely controlling the conduction time of the second switch unit, it is ensured that the Vth compensation time can be longer than the one-line scan time, which further enhances the effect of Vth compensation, and the accuracy of Vth compensation can be ensured even at a high refresh rate, thereby remarkably improving the display quality at a high refresh rate. The source electrode potential of the driving unit is reset in a pulse mode in the light-emitting phase through the timing control circuit, so that the hysteresis effect of the driving transistor is effectively restrained, and screen flicker under a low refresh rate is reduced. The use of low leakage transistors such as double-gate TFTs or IGZO TFTs in combination can further reduce charge leakage, supporting lower refresh rates, for example below 30 Hz, even up to around ~1 Hz. The 10T3C circuit proposed in some embodiments of the present disclosure, that is, the pixel circuit including 10 transistors and 3 capacitors, can better balance Vth compensation at a high refresh rate and flicker suppression at a low refresh rate through the circuit design and timing control in the embodiments of the present disclosure, thereby realizing a wider range of dynamic refresh rate support. Particularly, by using a double-gate TFT or an IGZO TFT with low leakage combined with the second capacitor C2 and the third capacitor C3, the leakage current of the circuit can be further reduced, the low-frequency driving capability is improved, and a lower refresh rate, for example, ~1 Hz is supported. Through the combined application of the technical means, the pixel driving circuit, the driving method and the display panel of the present disclosure can effectively support a dynamic refresh rate of wide range, at least the dynamic refresh rate of 30 Hz~240 Hz can be realized, and the pixel driving circuit can be further expanded to a high refresh rate higher than 240 Hz and a low refresh rate lower than 30 Hz and even reach about ~1 Hz through optimizing circuit design and device selection. The display device can flexibly switch the refresh rate under different application scenes, for example, the refresh rate is high when a high-frame-rate game or video is played so as to obtain smooth pictures, and the refresh rate is low when a static webpage is browsed or an electronic book is read, to reduce power consumption, thereby improving the user experience to the greatest extent and prolonging the endurance time of the device.

The pixel driving circuit and the display panel of the present disclosure respectively control the conduction and cut-off of the first switch unit and the second switch unit through the timing control circuit, and completely separate the data signal writing time and the threshold voltage compensation time, so that the threshold voltage compensation process is not limited by the scanning time of each row of pixels, and the full threshold voltage compensation can be performed at the high refresh rate, thereby effectively improving the uniformity of the display picture and eliminating the problems of brightness deviation, ghost and the like. By precisely controlling the conduction time of the second switch unit, the present disclosure ensures that the threshold voltage compensation time can be longer than a line scan time (one-line scan time), which further enhances the effect of threshold voltage compensation, and ensures the accuracy of threshold voltage compensation even at high refresh rates, thereby significantly improving the display quality at high refresh rates. In the present disclosure, in the light-emitting phase, the pulse signals are output to the third control signal terminal through the timing control circuit, and the conduction and cut-off of at least two switch units connected to the driving unit are controlled, so that the pulse reset of the potential of the driving unit is realized. The repeated reset effectively inhibits the hysteresis effect of the driving transistor and reduces the instability of OLED luminescence, thereby significantly reducing screen flicker under low refresh rate and improving viewing comfort.

The foregoing is a further detailed description of the present disclosure in connection with the preferred implementations, and it is not intended that the present disclosure be limited to the specific implementations described. It will be apparent to those skilled in the art that several simple deductions or substitutions may be made without departing from the spirit of the present disclosure, and these should be considered to be within the protection scope of the present disclosure.

What is claimed is:

1. A pixel driving circuit, comprising:
a driving unit for driving a light-emitting element to emit light;
a first switch unit for receiving a data signal of a data input terminal and transmitting the data signal to a fourth node;
a second switch unit for controlling threshold voltage compensation and transmitting a compensated voltage to a second node;
a first storage unit connected between the fourth node and the second node;
a timing control circuit for outputting a control signal to a first control signal terminal, a second control signal terminal, a third control signal terminal and a fourth control signal terminal respectively to control a conduction and cut-off of the first switch unit and the second switch unit, thereby separating a data signal writing time from a threshold voltage compensation time, and to control a conduction time of the second switch unit to enable the threshold voltage compensation time to be longer than a line scan time; and in a light-emitting phase, outputting a pulse signal to the third control signal terminal to pulse-reset the driving unit.

2. The pixel driving circuit according to claim 1, wherein the first switch unit comprises a first transistor, a gate of the first transistor is connected to the first control signal terminal, a first terminal of the first transistor is connected to the data input terminal, and a second terminal of the first transistor is connected to the fourth node.

3. The pixel driving circuit according to claim 1, wherein the second switch unit comprises a third transistor, a gate of the third transistor is connected to the second control signal terminal, a first terminal of the third transistor is connected to a third node, and a second terminal of the third transistor is connected to the second node.

4. The pixel driving circuit according to claim 1, further comprising a third switch unit, wherein the third switch unit comprises a sixth transistor, the sixth transistor is a double-gate thin film transistor, a gate of the sixth transistor is connected to the fourth control signal terminal, a first terminal of the sixth transistor is connected to a first reference voltage input terminal, and a second terminal of the sixth transistor is connected to the second node.

5. The pixel driving circuit according to claim 4, further comprising a third storage unit connected between a midpoint of the double-gate thin film transistor of the sixth transistor and the gate of the sixth transistor for stabilizing a potential of the second node.

6. The pixel driving circuit according to claim 1, further comprising:
a fourth switch unit connected between a second reference voltage input terminal and a fifth node; and
a fifth switch unit connected between the driving unit and a third reference voltage input terminal; wherein the timing control circuit respectively controls a conduction and cut-off of the fourth switch unit and the fifth switch unit through the third control signal terminal, to realize pulse reset of the driving unit.

7. The pixel driving circuit according to claim 6, wherein the fourth switch unit comprises a seventh transistor, a gate of the seventh transistor is connected to the third control signal terminal, a first terminal of the seventh transistor is connected to a second reference voltage input terminal, and a second terminal of the seventh transistor is connected to a fifth node; and the fifth switch unit comprises an eighth transistor, a gate of the eighth transistor is connected to the third control signal terminal, a first terminal of the eighth transistor is connected to a third reference voltage input terminal, and a second terminal of the eighth transistor is connected to the first node.

8. The pixel driving circuit according to claim 1, wherein at least the transistor in the first switch unit and the transistor in the second switch unit are double-gate thin film transistors.

9. The pixel driving circuit according to claim 2, wherein at least the transistor in the first switch unit and the transistor in the second switch unit are double-gate thin film transistors.

10. The pixel driving circuit according to claim 1, wherein the light-emitting element is an organic light emitting diode.

11. The pixel driving circuit according to claim 2, wherein the light-emitting element is an organic light emitting diode.

12. A display panel comprising a pixel driving circuit, wherein the pixel driving circuit comprises:
a driving unit for driving a light-emitting element to emit light;
a first switch unit for receiving a data signal of a data input terminal and transmitting the data signal to a fourth node;
a second switch unit for controlling threshold voltage compensation and transmitting a compensated voltage to a second node;
a first storage unit connected between the fourth node and the second node;
a timing control circuit for outputting a control signal to a first control signal terminal, a second control signal terminal, a third control signal terminal and a fourth control signal terminal respectively to control a conduction and cut-off of the first switch unit and the second switch unit, thereby separating a data signal writing time from a threshold voltage compensation time, and to control a conduction time of the second switch unit to enable the threshold voltage compensation time to be longer than a line scan time; and in a light-emitting phase, outputting a pulse signal to the third control signal terminal to pulse-reset the driving unit.

13. The display panel according to claim 12, wherein the first switch unit comprises a first transistor, a gate of the first transistor is connected to the first control signal terminal, a first terminal of the first transistor is connected to the data input terminal, and a second terminal of the first transistor is connected to the fourth node.

14. The display panel according to claim 12, wherein the second switch unit comprises a third transistor, a gate of the third transistor is connected to the second control signal terminal, a first terminal of the third transistor is connected to a third node, and a second terminal of the third transistor is connected to the second node.

15. The display panel according to claim 12, wherein the pixel driving circuit further comprises a third switch unit, wherein the third switch unit comprises a sixth transistor, the sixth transistor is a double-gate thin film transistor, a gate of the sixth transistor is connected to the fourth control signal terminal, a first terminal of the sixth transistor is connected to a first reference voltage input terminal, and a second terminal of the sixth transistor is connected to the second node.

16. The display panel according to claim 15, wherein the pixel driving circuit further comprises a third storage unit connected between a midpoint of the double-gate thin film transistor of the sixth transistor and the gate of the sixth transistor for stabilizing a potential of the second node.

17. The display panel according to claim 12, wherein the pixel driving circuit further comprises:
a fourth switch unit connected between a second reference voltage input terminal and a fifth node; and
a fifth switch unit connected between the driving unit and a third reference voltage input terminal; wherein the timing control circuit respectively controls a conduction and cut-off of the fourth switch unit and the fifth switch unit through the third control signal terminal, to realize pulse reset of the driving unit.

18. The display panel according to claim 17, wherein the fourth switch unit comprises a seventh transistor, a gate of the seventh transistor is connected to the third control signal terminal, a first terminal of the seventh transistor is connected to a second reference voltage input terminal, and a second terminal of the seventh transistor is connected to a fifth node; and
the fifth switch unit comprises an eighth transistor, a gate of the eighth transistor is connected to the third control signal terminal, a first terminal of the eighth transistor is connected to a third reference voltage input terminal, and a second terminal of the eighth transistor is connected to the first node.

19. The display panel according to claim 12, wherein at least the transistor in the first switch unit and the transistor in the second switch unit are double-gate thin film transistors.

20. The display panel according to claim 12, wherein the light-emitting element is an organic light emitting diode.
